(19) United States
(12) Patent Application Publication
(10) Pub. No.: US 2017/0074480 A1
(43) Pub. Date: Mar. 16, 2017

(54) VEHICLE LAMP

(71) Applicant: ICHIKOH INDUSTRIES, LTD., Isehara-shi, Kanagawa-ken (JP)

(72) Inventors: Shinobu TOMITA, Isehara-shi, Kanagawa (JP); Eiji SUZUKI, Isehara-shi, Kanagawa (JP)

(73) Assignee: ICHIKOH INDUSTRIES, LTD., Isehara-shi, Kanagawa-ken (JP)

(21) Appl. No.: 15/309,069

(22) PCT Filed: Apr. 10, 2015
(86) PCT No.: PCT/JP2015/061248

§ 371 Date: Nov. 4, 2016

(30) Foreign Application Priority Data
May 7, 2014 (JP) 2014-096087

(51) Int. Cl. F21S 8/10; F21V 29/76; F21V 29/503

(52) U.S. Cl. CPC F21S 48/328; F21V 29/503; F21V 29/763; F21S 48/1145; F21S 48/1104; F21S 48/1233; F21S 48/1388; F21S 48/1317; F21S 48/1305

(57) ABSTRACT

This vehicle lamp is provided with the following: a first light source; a second light source provided further on the outer side of a vehicle than the first light source; a heatsink having a base part on which the first light source and the second light source are mounted; and a through hole that penetrates the base part and that is formed at a position on a straight line connecting the first light source and the second light source in top view in which the base part is viewed from the upper side of the vehicle.

### TECHNICAL FIELD

The present invention relates to a vehicle lamp.

### BACKGROUND ART

Conventionally, in Patent Literature 1, there is disclosed a vehicle lamp in which two light sources have been provided at a base part of a heat sink. In the vehicle lamp, in order to restrain heat transmission between the light sources, the base part is formed in a shape in which a recessed groove substantially longitudinally crossing light source placement surfaces between has been provided so that light source placement surfaces of the base part at which the respective light sources have been disposed are spaced from each other.

### CITATION LIST

### Patent Literature

Patent Literature 1: Japanese Unexamined Patent Application Publication No. 2011-28963

### SUMMARY OF THE INVENTION

### Problems to be Solved by the Invention

However, if the shape in which the recessed groove substantially crossing the light source placement surface between has been provided is thus formed, there is an apprehension that the strength of a structural portion which connects these two light source placement surfaces to each other lowers and then a deformation or the like occurs with the structural portion of connection.

The present invention has been made in view of such a circumstance, and it is an object of the present invention to provide a vehicle lamp restraining heat transmission between light sources while restraining lowering of a strength of a base part.

The present invention is realized by the following configuration in order to achieve the above object.

(1) A vehicle lamp according to the present invention comprising: a first light source; a second light source which is provided at a vehicular outside more significantly than the first light source; a heat sink having a base part on which the first light source and the second light source are to be placed; and a through hole to penetrate the base part that is formed at a position on a straight line which connects the first light source and the second light source to each other in a top view in a case where the base part is seen from a vehicular upper side.

(2) The vehicle lamp according to the configuration of the (1), wherein the base part is a stepped shape which is provided with: a first light source mounting surface for mounting the first light source; a second light source mounting surface for mounting the second light source, which is positioned at a vehicular outside more significantly than the first light source mounting surface and at the vehicular upper side; and a longitudinal wall surface that connects the first light source mounting surface and the second light source mounting surface, and the through hole is formed at least on the longitudinal wall surface.

(3) The vehicle lamp according to the configuration of the (1), comprising: a first reflector which is disposed to oppose to the first light source and is fixed to a first screw fastening part of the base part with screw; and a second reflector which is disposed to oppose to the second light source and is fixed to a second screw fastening part of the base part with screw, wherein the through hole is formed at a position between the first screw fastening part that is positioned at the second reflector's side and the second screw fastening part that is positioned at the first reflector's side.

(4) The vehicle lamp according to the configuration of the (1), comprising a plurality of heat radiation fins which are arranged in a vehicular widthwise direction and are provided on an opposite surface to a surface on which the first light source and the second light source of the base part are to be placed, wherein at least one of the heat radiation fins is provided so as to overhang an opening of the through hole.

### EFFECT OF THE INVENTION

According to the present invention, it is possible to provide a vehicle lamp restraining heat transmission between light sources while restraining lowering of a strength of a base part.

### BRIEF DESCRIPTION OF THE DRAWINGS

FIG. 1 is a plan view of a vehicle equipped with a vehicle lamp of an embodiment.

FIG. 2 is a front view in a case where a light source unit is seen from a vehicular front side while a housing and an outer lens are omitted from the vehicle lamp of FIG. 1.

FIG. 3 is a top view in a case where the light source unit of FIG. 2 is seen from a vehicular upper side.

FIG. 4 is a perspective view in a case where the light source unit of

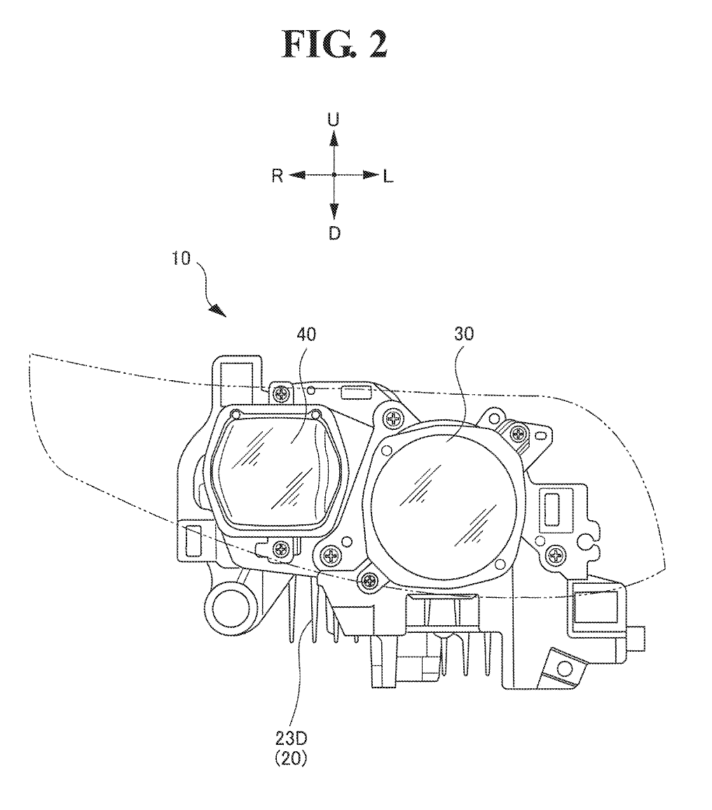

FIG. 2 is seen from a vehicular central side.

FIG. 5 is a bottom view in a case where the light source unit of FIG. 2 is seen from a vehicular lower side.

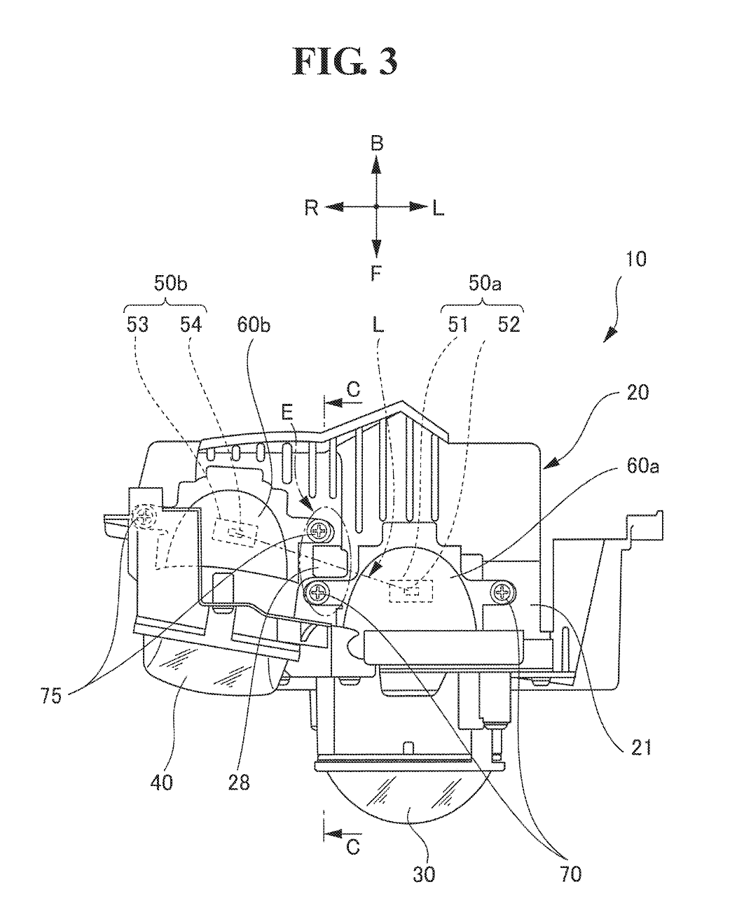

FIG. 6 is an enlarged view in a case where the portion E of FIG. 3 is enlarged.

FIG. 7 is a sectional view taken along the line C-C.

### MODE FOR CARRYING OUT THE INVENTION

Mode for carrying out the present invention (hereinafter, referred to as the “embodiment”) will be described in detail with reference to the drawings. Throughout the entire description of the embodiment, the same constituent elements are designated by the same reference numerals. It is to be noted that, in the present specification, the forward, backward, upper, lower, leftward, and rightward directions respectively designate the directions as seen from a driver riding on a vehicle in a case where a vehicle lamp has been mounted to the vehicle.

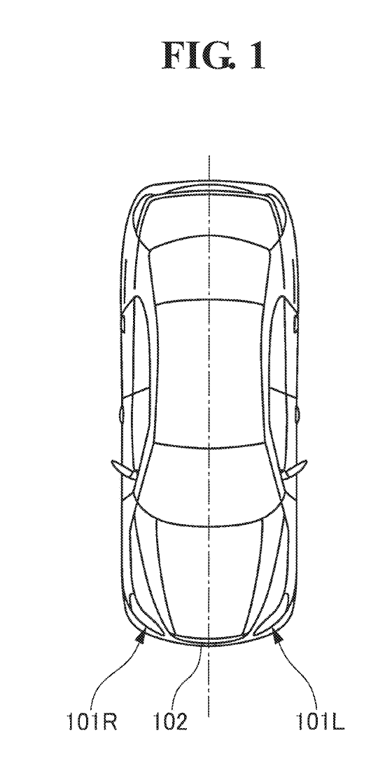

Vehicle lamps according to the embodiment of the present invention are vehicle lamps (101R, 101L) which are respectively provided at the front left and right of a vehicle 102 shown in FIG. 1, and the constituent elements of the left and right vehicle lamps (101R, 101L) are transversely symmetrical to each other; and therefore, hereinafter, only the vehicle lamp 101R at the right side will be described. Hereinafter, it is to be noted that the vehicle lamp 101R is referred to as the “vehicle lamp”.

(Entire Configuration of Vehicle Lamp)

The vehicle lamp of the embodiment has a basic configuration in which a lamp source unit has been disposed in a lamp room which is made of a housing having an opening at a vehicular front side; and an outer lens which is mounted in the housing so as to cover the opening.

FIG. 2 is a front view when the vehicle lamp of the embodiment is seen from the vehicular front side, in which a portion at which the outer lens is position is indicated by the double-dotted diagonal line, and shows a light source unit 10 while the housing and the outer lens are omitted. It is to be noted that, in FIG. 2, the right side is a vehicular central side, and the left side is a vehicular outside.

(Light Source Unit)

As shown in FIG. 2, the light source unit 10 has: a heat sink 20; and a non-spherical lens 30 and a cylindrical lens 40 which are mounted to the heat sink 20 via a lens holder. FIG. 3 is a top view in a case where the light source unit 10 is seen from the vehicular upper side. As shown in FIG. 3, the light source unit 10 is equipped with: a first light source 50a which is mounted to the heat sink 20 and is provided at the vehicular central side; and a second light source 50b which is provided at the vehicular outside.

In addition, the light source unit 10 is equipped with: a first reflector 60a formed in a shape of a semicircular dome, which is disposed to oppose to the first light source 50a so as to cover the vehicular upper side of the first light source 50a ; and a second reflector 60b formed in a shape of a semicircular dome, which is disposed to oppose to the second light source 50b so as to the vehicular upper side of the second light source 50b.

Light from the first light source 50a is reflected to the non-spherical lens 30 so as to be a focusing light distribution pattern of a low beam light distribution pattern, for example, by the first reflector 60a, and then, the reflected beam is radiated to the vehicular front side via the non-spherical lens 30. In addition, light from the second light source 50b is reflected to the cylindrical lens 40 so as to be a diffusive light distribution pattern of a lower beam light distribution pattern, for example, by the second reflector 60b, and then, the reflected beam is radiated to the vehicular front side via the cylindrical lens 40. The focusing light distribution pattern and diffusive light distribution pattern are multiplexed with each other, and a low beam light distribution pattern is thereby formed.

It is to be noted that the light distribution pattern that is formed by the vehicle lamp of the present invention is not limitative to the low beam light distribution pattern, and may be a pattern to form a high beam light distribution pattern. In addition, the lens is not limitative to the non-spherical lens 30 and the cylindrical lens 40, and may be appropriately changed to another lens.

(First Light Source and Second Light Source)

A semiconductor-type light source is employed for each of the first light source 50a and the second light source 50b. In so far as the semiconductor-type light source is concerned, as shown in FIG. 3, self-emission semiconductor-type light emitting elements 52, 54 such as an LED or an EL (an organic EL), for example, are respectively implemented on boards 51, 53 on which a power supply pattern or the like, although not shown, has been formed. The number and shape of the semiconductor-type light emitting elements 52, 54 that are employed to form a light emitting portion are not limitative in particular, and for example, it may be that a plurality of semiconductor-type light emitting elements 52, 54 formed in a square shape are arrayed on the board 51, 53 in a horizontal direction so as to form a light emission surface formed in a planar rectangular shape as a whole, or alternatively, only one semiconductor-type light emitting element 52, 54 formed in a square shape or in a rectangular shape is provided so as to form a light emission surface. In addition, the semiconductor-type light emitting elements 52, 54 may be packaged by being sealed with a sealing resin.

(Heat Sink)

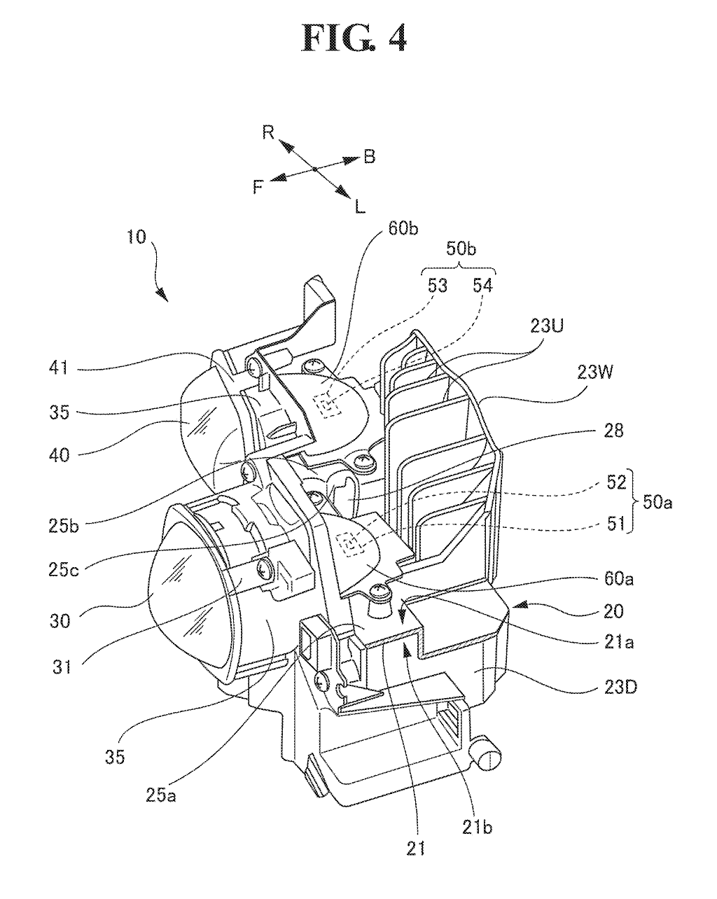

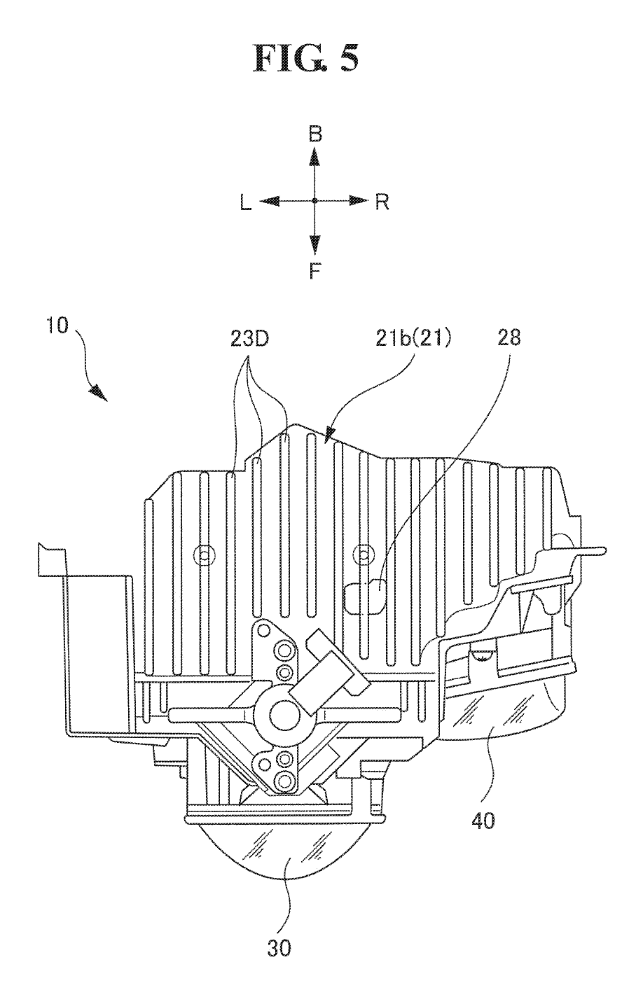

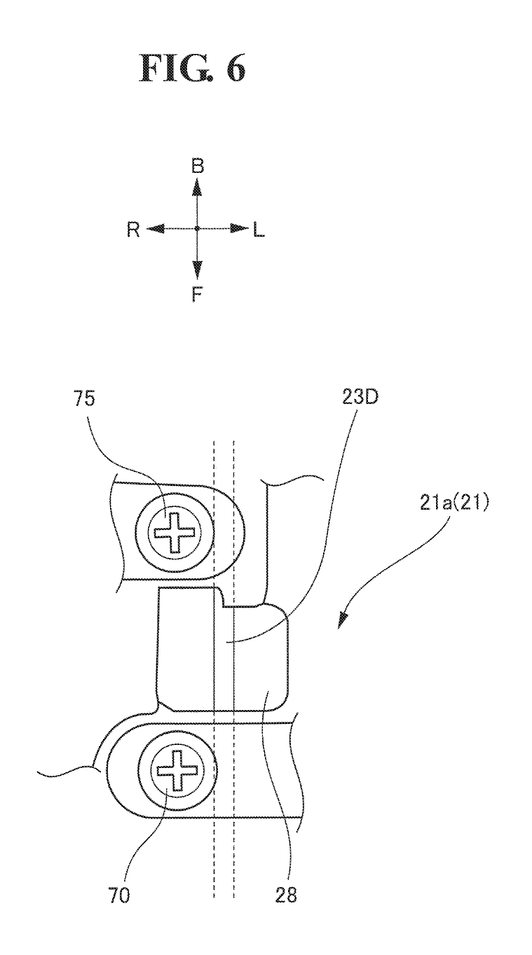

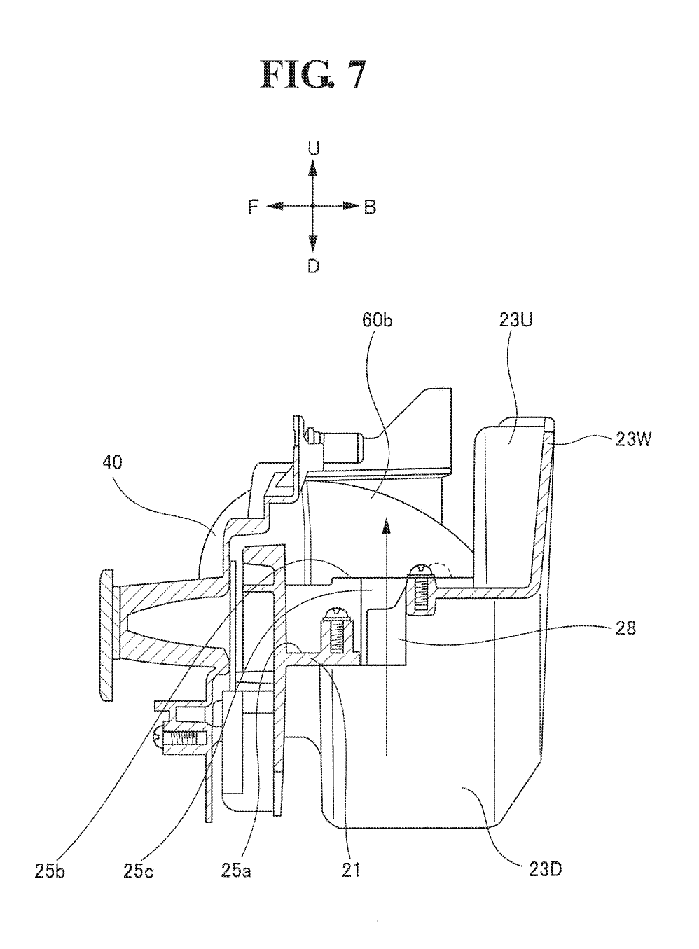

The heat sink 20 is made of a metal member or a resin member of which thermal conductivity is high, and in the embodiment, the heat sink is made of an aluminum die cast. FIG. 4 is a perspective view in a case where the light source unit 10 is seen from the vehicular central side. As shown in FIG. 4, the heat sink 20 is equipped with: a base part 21 on which the first light source 50a and the second light source 50b are to be placed; a plurality of heat radiation fins 23 which are provided at the vehicular upper side of the base part 21; and a heat radiation fin 23D which is provided on a face 21b (a back face) opposite to a face 21a (a surface) on which the first light source 50a and the second light source 50b of the base part 21 are to be placed.

The heat radiation fin 23D is formed so that one end thereof connects to the back face of the base part and extends to the vehicular lower side. FIG. 5 is a bottom view in a case where the light source unit 10 is seen from the vehicular lower side. As shown in FIG. 5, the heat radiation fin 23D is provided in plurality so as to be arranged in the vehicular widthwise direction.

The heat radiation fins 23U, as shown in FIG. 4, are formed toward the vehicular front side from a longitudinal wall 23W which extends from a rear end of the base part 21 (a vehicular end part) towards the vehicular upper side). It is to be noted that, although not shown in FIG. 4, a lower part of each of the heat radiation fins 23U connects to the base part 21.

Further, a lens holder 35 is provided at the vehicular front side of the heat sink 20, and the non-spherical lens 30 and the cylindrical lens 40 are mounted to the lens holder 35 by a retainer 31 and a retainer 41, respectively.

Hereinafter, a structure of the heat sink 20 will be described in further detail. Although a heat to be radiated from the semiconductor-type light emitting element 52 when the first light source 50a emits light is radiated from the heat radiation fins 23U and the heat radiation fins 23D through the base part 21 of the heat sink 20, all of the heat does not travel to the heat radiation fins 23U, 23D, and a part of the heat becomes a cause of a temperature rise of the second light source 50b via the heat sink 20, and light emission efficiency of the second light source 50b lowers.

Similarly, all of a heat which is radiated from the semiconductor-type light emitting element 54 when second light source 50b emits light does not travel to the heat radiation fins 23U, 23D, and a part of the heat becomes a cause of a temperature rise of the first light source 50a via the heat sink 20, and light emission efficiency of the first light source 50a lowers. The straight line L of the double-dotted diagonal line shown in FIG. 3 indicates a straight line which connects the semiconductor-type light emitting element 52 of the first light source 50a and the semiconductor-type light emitting element 54 of the second light source 50b to each other. A route in which the largest amount of the heat is to be transmitted from one light source (for example, the first light source 50a) side to the other light source (for example, the second light source 50b) side as has been described hereinabove is the shortest route that is indicated by the straight line L.

Therefore, as shown in FIG. 3, at a position on the straight line L, a through hole 28 which penetrates the base part 21 is formed, and heat transmission in the shortest route is thereby restrained, and the temperature rise of the light source (the first light source 50a, the second light source 50b) is restrained, and lowering of the light emission efficiency is thereby restrained.

Hereinafter, with reference to FIG. 4, the through hole 28 will be described in further detail. As shown in FIG. 4, the base part 21 is formed in a stepped shape which is provided with: a first light source mounting surface 25a for mounting the first light source 50a; a second mounting mounting surface 25b for mounting the second light source 50b which is provided so as to be higher by one step so as to be positioned at the vehicular outside more significantly than the first light source mounting surface 25a and at the vehicular upper side; and a longitudinal wall surface 25c which connects the first light source mounting surface 25a and the second light source mounting surface 25b to each other.

In addition, the through hole 28, a part of which is not shown in FIG. 4, is formed all over the first light source mounting surface 25a from the longitudinal wall surface 25c. Incidentally, although the embodiment shows the case in which the through hole 28 is formed all over the first light source mounting surface 25a from the longitudinal wall surface 25c, without being limitative thereto, for example, it may be the through hole 28 is formed from the first light source mounting surface 25a up to the second light source mounting surface 25b via the longitudinal wall surface 25c and then the through hole 28 is formed so as to overhang the stepped shape.

In addition, as shown in FIG. 3, the through hole 28 is provided at a position between screws for fixing the first reflector 60a and the second reflector 60b to each other. In more detail, as shown in FIG. 3, the first reflector 60a is fixed to the base part 21 with screws 70 at two positions which are a position at the vehicular central side and a position at the vehicular outside. At positions of the base part 21, which correspond to the positions of the screws 70 shown in FIG. 3, first screw fastening parts for fastening the first reflector 60a with screws are formed. Similarly, the second reflector 60b is also fixed to the base part 21 with screws 75 at two positions which are a position at the vehicular central side and at a position at the vehicular outside, and at the positions of the base part 21, which correspond to the positions of the screws 75 shown in FIG. 3, second screw fastening parts for fastening the second reflector 60b with screws are formed.

In addition, as is obvious from FIG. 3, the through hole 28 is formed at a position between a first screw fastening part which is positioned at the second reflector 60b, of the two first screw fastening parts that are provided at the base part 21 for fixing the first reflector 60a ; and a second screw fastening part which is positioned at the first reflector 60a side, of the two second screw fastening parts that are provided at the base part 21 for fixing the second reflector 60b.

FIG. 6 is an enlarged view of the portion E of FIG. 3, namely is an enlarged view of the periphery of the through hole 28. As is obvious by referring to FIG. 6 and FIG. 5 which is a bottom view in a case where the light source unit 10 is seen from the vehicular lower side, one of the plurality of heat radiation fins 23D that are provided on the back face (the face 21b) of the base part 21 is provided so as to overhang the through hole 28 in the vehicular forward and backward directions. It is to be noted that the number of heat radiation fins 23D that are provided so as to overhang the through hole 28 may be in plurality without being limitative to only one, and it may be that no heat radiation fin 23D is provided so as to overhang the through hole 28. However, as described later, it is preferable to provide the heat radiation fins 23D so as to overhang the through hole 28.

### Functions and Advantageous Effects of the Embodiment

As has been described hereinabove, the through hole 28 that penetrates the base part 21 is provided at the position on the straight line L (on the shortest route) that connects the first light source 50a and the second light source 50b to each other. Therefore, an occurrence of heat transmission between the light sources (the first light source 50a, the second light source 50b) via the shortest route is restrained, thus making it possible to reduce the quantity of the heat that is transmitted from one light source to the other light source.

On the other hand, if the temperature at the periphery of the through hole 28 rises due to the heat that has been thermally transmitted via the shortest route, the air that is heated by the heat becomes a rising airflow. FIG. 7 is a sectional view taken along the line C shown in FIG. 3. As described above, if the rising airflow arises, as indicated by the arrow in FIG. 7, a fresh air flows from the vehicular lower side into the through hole 28, as it were drawn by the rising airflow; and therefore, the periphery of the through hole 28 is effectively cooled.

The position at which the through hole 28 is provided, as has been described hereinabove, is present on the shortest route between the light sources (the first light source 50a, the second light source 50b) and thus it is possible to cool is a position at which the heat is most likely to gather, and the position at which the heat is most likely to gather; and therefore, the heat radiation effect is enhanced.

At the position of the through hole 28, as shown in FIG. 5 and FIG. 6, the heat radiation fins 23D are also provided so as to overhang the through hole 28, and by the heat radiation fins 23D, the heat radiation effect is further enhanced, and moreover, as described above, at this portion, the airflow is formed; and therefore, the heat radiation effect of the heat radiation fins 23D is more remarkably enhanced.

In addition, as shown in FIG. 6, the through hole 28 is provided between the first screw fastening parts at which the screws 70 for fixing the first reflector 60a are provided and the second screw fastening parts at which the screws 75 fixing the second reflector 60b therewith are provided; and therefore, these screw fastening parts (the first screw fastening parts, the second screw fastening parts) are also cooled due to the airflow that passes through the through hole 28. Therefore, looseness or the like of the screws 70, 75, which may occur under the influence of thermal expansion or the like, is also restrained.

Further, as shown in FIG. 7, the second light source mounting surface 25b is positioned at the vehicular upper side more significantly than the first light source mounting surface 25a, and the shape (the stepped shape) that is provided with the longitudinal wall surface 25c to connect the first light source mounting surface 25a and the second light source mounting surface 25b to each other is formed. Therefore, in comparison with a case in which the first light source mounting surface 25a and the second light source mounting surface 25b are set at the same position at the same height at the vehicular upper side, and the first light source mounting surface 25a and the second light source mounting surface 25b connect to each other on a face-to-face basis, a distance of heat transmission from one light source (for example, the first light source 50a) to the other light source (for example, the second light source 50b) is increased by the longitudinal wall surface 25c thus provided; and hence, the heat is hardly transmitted.

In the longitudinal wall surface 25c, the through hole 28 through which air flows is provided, and a part of the air that flows the through hole 28 also flows along the longitudinal wall surface 25c at the periphery of the through hole 28; and therefore, the longitudinal wall surface 25c per se attains an advantageous effect similar to that of the heat radiation of which cooling efficiency is good, and heat transmission between the light sources (the first light source 50a, the second light source 50b) is more remarkably restrained.

On the other hand, in the embodiment, the through hole 28 was merely formed at a part of the shortest route on which the heat is most likely to be transmitted and thus lowering of the rigidity of the heat sink 20 is restrained. Moreover, the heat radiation fins 23D that have been provided so as to overhang the through hole 28 also attains an advantageous effect of a reinforcement rib. In addition, the through hole 28 was formed, making it possible to reduce the weight of the heat sink 20, accordingly.

As described above, heat radiation on the shortest route on which the heat is most likely to be transmitted can be carried out to thereby conversely enable a design modification such as reduction of a heat radiation fin of which heat radiation efficiency is low at a position which is distant from the light sources (the first light source 50a, the second light source 50b) of the heat sink 20, making it possible to reduce the weight of the heat sink 20, and due to this reduction, making it also possible to reduce the size of the heat sink 20 per se.

As described above, the present invention is not limitative to the above described embodiment, alterations or modifications or the like in the scope in which the object of the present invention can be achieved are also encompassed in the present invention.

1. A vehicle lamp comprising:
a first light source;
a second light source which is provided at a vehicular outside more significantly than the first light source;
a heat sink having a base part on which the first light source and the second light source are to be placed; and
a through hole to penetrate the base part that is formed at a position on a straight line which connects the first light source and the second light source to each other in a top view in a case where the base part is seen from a vehicular upper side.

2. The vehicle lamp according to claim 1, wherein
the base part is a stepped shape which is provided with:
a first light source mounting surface for mounting the first light source;
a second light source mounting surface for mounting the second light source, which is positioned at a vehicular outside more significantly than the first light source mounting surface and at the vehicular upper side; and
a longitudinal wall surface that connects the first light source mounting surface and the second light source mounting surface, and
the through hole is formed at least on the longitudinal wall surface.

3. The vehicle lamp according to claim 1, comprising:
a first reflector which is disposed to oppose to the first light source and is fixed to a first screw fastening part of the base part with screw; and
a second reflector which is disposed to oppose to the second light source and is fixed to a second screw fastening part of the base part with screw,
wherein the through hole is formed at a position between the first screw fastening part that is positioned at the second reflector's side and the second screw fastening part that is positioned at the first reflector's side.

4. The vehicle lamp according to claim 1, comprising a plurality of heat radiation fins which are arranged in a vehicular widthwise direction and are provided on an opposite surface to a surface on which the first light source and the second light source of the base part are to be placed,
wherein at least one of the heat radiation fins is provided so as to overhang an opening of the through hole.
